(19) United States
(12) Patent Application Publication
(10) Pub. No.: US 2014/0053488 A1
(43) Pub. Date: Feb. 27, 2014

(54) INSERTS FOR HOLLOW STRUCTURAL MEMBERS

(71) Applicants: Ronald M. Lenox, Cranberry Township, PA (US); Sneh Kumar, Pittsburgh, PA (US)

(72) Inventors: Ronald M. Lenox, Cranberry Township, PA (US); Sneh Kumar, Pittsburgh, PA (US)

(73) Assignee: Alcoa Inc., Pittsburgh, PA (US)

(21) Appl. No.: 13/591,649

(22) Filed: Aug. 22, 2012

(51) Int. Cl. E06B 3/263; E04B 1/78

(52) U.S. Cl. 52/404.1; 49/404

(57) ABSTRACT

A pre-formed insert with stable dimensions for mechanical insertion into a hollow member and that reduces the Nusselt number and convection across the hollow member. The insert may be formed of a low heat conducting material like PVC and have extensions and internal voids that impede convection in the hollow and conduction through the insert. The inserts may be used in stiles, rails, heads and sills of aluminum windows and doors. In one embodiment an insert is received in an open hollow and may cooperate with an insert in a frame hollow to decrease convection at the head end of a sliding window or door. An insert may be placed within the hollow of a window or door beside a roller assembly.

### STATEMENT REGARDING FEDERALLY SPONSORED RESEARCH

The development of a portion of the disclosed subject matter was supported in part by funds from the U.S. Department of Energy Award No. DE-EE0004012. The U.S. government may have certain rights in the claimed subject matter.

### FIELD

The present invention relates to windows and doors, and more particularly, to apparatus and methods for changing the rate of energy transfer through doors, windows and assemblies having internal hollows.

### BACKGROUND

Windows, doors, skylights and structural components made from materials such as aluminum, alloys thereof, steel and plastics having internal hollows are known. For example, window and door assemblies may be made from aluminum alloy extrusions. Devices and methods have been proposed for altering the transfer of energy through such structural components, such as thermal breaks and various types of weather stripping. Notwithstanding, alternative methods, apparatus and manufactures for modifying energy transfer through windows, doors and other structural components having internal hollows remains desirable.

### SUMMARY

The disclosed subject matter relates to an insert for members made from a first material having a first thermal conductivity and having a hollow supporting heat transfer by convection. The insert has stable free-standing dimensions rendering the insert capable of insertion into the hollow and extending at least partially across the hollow when inserted therein. The insert is capable of reducing the Nusselt number of the member when inserted into the hollow relative to the Nusselt number of the member without the insert present in the hollow.

In accordance with another aspect of the present disclosure, the insert is made from a second material with a second thermal conductivity and has a cross-sectional shape which at least partially subdivides the hollow into a plurality of sub-areas.

In accordance with another aspect of the present disclosure, the insert has a cross-sectional shape with a wall having a first orientation and a second wall having an orientation disposed at an angle relative to the first wall.

In accordance with another aspect of the present disclosure, the first wall is disposed perpendicular to the second wall.

In accordance with another aspect of the present disclosure, the insert has a cross-sectional shape with a plurality of walls defining a grid.

In accordance with another aspect of the present disclosure, the member receiving the insert is a member of a door.

In accordance with another aspect of the present disclosure, the member receiving the insert is a member of a window.

In accordance with another aspect of the present disclosure, the member is at least one of a rail, stile, head and sill of a window.

In accordance with another aspect of the present disclosure, the member is at least one of a rail, stile, head and sill of a door.

In accordance with another aspect of the present disclosure, the member is made at least partially of metal and the fluid is air.

In accordance with another aspect of the present disclosure, the metal is an aluminum alloy and the insert is formed from a plastic.

In accordance with another aspect of the present disclosure, the plastic is at least one of PVC and polyurethane.

In accordance with another aspect of the present disclosure, the member has a closed cross-sectional shape.

In accordance with another aspect of the present disclosure, the member has an open cross-sectional shape, the hollow communicating with a space exterior to the member.

In accordance with another aspect of the present disclosure, the cross-sectional shape is C-shaped.

In accordance with another aspect of the present disclosure, the insert has a first wall extending at least partially across the opening in the C-shape.

In accordance with another aspect of the present disclosure, the insert further includes a wall extending at an angle from the first wall.

In accordance with another aspect of the present disclosure, the first wall engages the member at either end to retain the insert in association with the member.

In accordance with another aspect of the present disclosure, the second wall engages another portion of the member to support the insert in the member.

In accordance with another aspect of the present disclosure, the second wall extends distally to the member.

In accordance with another aspect of the present disclosure, the insert is disposed in a sill and the second wall is flexible.

In accordance with another aspect of the present disclosure, a sliding access device features a frame with a head having a first open hollow. A panel capable of sliding relative to the frame has a head with a second open hollow, the first open hollow and the second open hollow facing each other. A first insert capable of being received in the frame bridges the first open hollow and a second insert capable of being received in the panel bridges the second open hollow.

In accordance with another aspect of the present disclosure, the first insert has a cross-sectional shape with a U shape, and the second insert has a cross-sectional shape with a U shape, the U shape of the first insert and the U shape of the second insert cooperatively mating, such that the panel can be lifted into the frame and the cooperation of the first insert and the second insert is capable of reducing the heat transfer through the conjoined first and second hollows when the panel is installed in the frame.

In accordance with another aspect of the present disclosure, the frame and panel are made of a first material with a given thermal conductivity and the first and second inserts are formed of a second material having a lesser thermal conductivity.

In accordance with another aspect of the present disclosure, a sliding access device has a frame with a sill, a track disposed within the sill, a panel with a hollow disposed along a bottom portion of the panel, and a roller assembly disposed in the hollow for supporting the panel slidably within the frame. The roller assembly engages and rolls on the track. An insert is received within the hollow, the insert having an adjacent wall that extends adjacent to the bottom portion defining the hollow along at least a portion thereof, a proximate wall positioned proximate to the roller assembly and a bridging wall extending between the adjacent wall and the proximate wall, the insert decreasing the Nusselt number of the sliding access device relative to the Nusselt number of the sliding access device without the insert.

### BRIEF DESCRIPTION OF THE DRAWINGS

For a more complete understanding of the present invention, reference is made to the following detailed description of exemplary embodiments considered in conjunction with the accompanying drawings.

FIG. 1 is a front view of a vertically operating hung-type window assembly in accordance with an embodiment of the present disclosure.

FIG. 2 is a cross-sectional view of the hung-type window of FIG. 1, taken along section line 2-2 and looking in the direction of the arrows.

FIG. 3 is a cross-sectional view of the hung-type window of FIG. 1, taken along section line 3-3 and looking in the direction of the arrows.

FIG. 4 is a cross-sectional view like FIG. 3, but taken of a casement type window.

FIG. 5 is a front view of a sliding window/door assembly in accordance with an embodiment of the present disclosure.

FIG. 6 is a cross-sectional view of the sliding window/door of FIG. 5, taken along section line 6-6 and looking in the direction of the arrows.

FIG. 7 is a cross-sectional view of the sliding window/door of FIG. 5, taken along section line 7-7 and looking in the direction of the arrows.

### DETAILED DESCRIPTION OF EXEMPLARY EMBODIMENTS

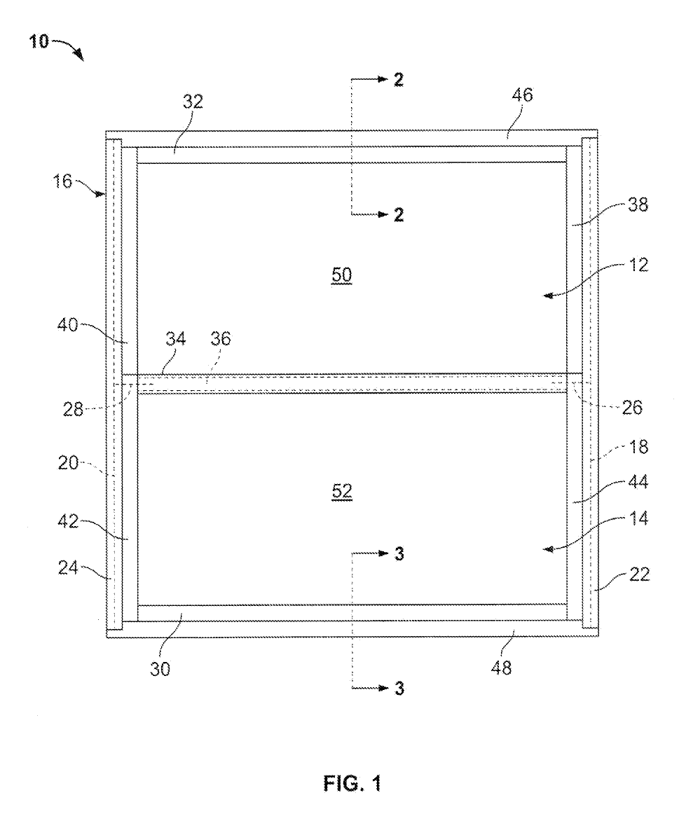

FIG. 1 shows a window assembly 10 having upper and lower sashes 12, 14 held within frame 16. In the case of a hung window, typically at least one of the sashes 12, 14 slides within opposing tracks 18, 20 (shown diagrammatically in dotted lines) in jambs 22, 24 to allow opening/closing the window assembly 10. Alternatively, with double-hung windows, both sashes 12, 14 slide up and down. With single-hung windows, only the lower sash 14 slides up and down. With casement windows, hinges/pivots 26, 28 (diagrammatically shown in dotted lines) allow one of sashes 12, 14 to tip in or out relative to the frame 16, the other being stationary. Alternatively, both sashes 12, 14 may be hinge mounted. The sashes 12, 14 feature horizontally oriented rails 30, 32 (the upper check rail 34 of the lower sash 14 coinciding with the lower check rail 36 (dotted lines) of the upper sash 12) and vertically oriented stiles 38, 40, 42, 44. The upper part of the frame 12 is the head 46 and the lower part, the sill 48. The glazing 50, 52, e.g., glass or plastic is held within the sashes 12, 14.

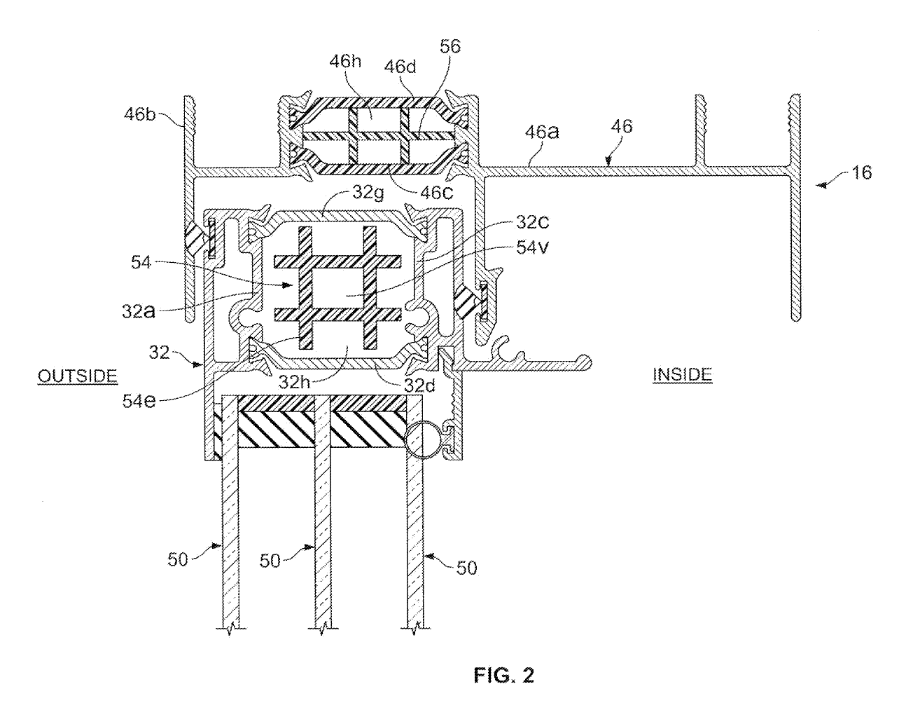

FIG. 2 shows that the rail 32 may be formed from a plurality of sub-parts 32a-32d, e.g., in the form of extrusions, which are assembled together to form the rail 32, which has an internal hollow 32h. An insert 54 has been inserted into the hollow 32h for modifying the flow of heat through the rail 32 between the inside and outside. For example, on a cold day, warm inside air would heat the extrusion 32c which would conduct heat to extrusions 32b and 32d and then to 32a. In addition, heat would flow through the rail 32 via convection, the warmed extrusions 32c, 32b and 32d would lose heat to the air contained in the hollow 32h, which would then transfer this heat energy to the cold outside extrusion 32a, such that a continual heat transfer from inside to outside would occur. By at least partially diminishing the transfer of heat through the gas, e.g., air, within the hollow 32h via convection, the insert 54 may have a beneficial effect on the energy efficiency of the window, reducing the U value, the overall heat transfer coefficient and the Nusselt number, the ratio of convection heat transfer to conductive heat transfer. As is known, it is at times desirable to limit the heat transfer from outside to inside, e.g., during hot summer days, when it is preferable to maintain the inside of a structure cooler than the outside. In cold weather, the opposite objective is typically sought. The insert 54 may be formed from a material which has lower heat conducting capacity, such as a plastic like PVC or polyurethane and may have internal voids 54v, as well as extensions 54e which enlarge the geometry and gas/air movement blocking capability of the insert 54, while diminishing weight. The voids 54v also constitute a pocket of still gas/air captured within the insert 54 and therefore add to the insulating properties of the insert 54. The insert 54 may be proportioned relative the hollow 32h to allow the insert 54 to be slipped into the hollow 32h through an open end or to enable the insert 54 to be placed in a partially formed rail 32, e.g., after assembly of three of the subsections, e.g., 32a-c. The other rails 30, 34, 36 and stiles 38, 40, 42, 44 in the sashes 12, 14 may be similarly treated by the insertion of an insert like insert 54. While the foregoing description refers to structural members, such as rail 32 being formed from a plurality of sub-parts, e.g., 32a-32d, the present disclosure is applicable to structural members, such as rail 32 which is formed from fewer sub-parts or is monolithic, e.g., an extruded tube, having a square, rectangular or other cross-sectional shape, which defines a hollow, like hollow 32h into which an insert, like insert 54, may be placed. This observation is applicable to the other composite structural members referred to below.

FIG. 2 shows that the head 46 of the frame 16 may be formed from a plurality of subsections 46a, 46b, which are bridged by thermal breaks 46c, 46d made from a material, e.g., a polymer, that has a reduced heat conductivity relative to the subsections 46a, 46b. In this manner, the thermal breaks 46c, 46d decrease heat conduction through the frame. As shown, the thermal breaks 46c, 46d define a hollow 46h there between. An insert 56 may be inserted into the hollow 46h to subdivide the volume of the hollow 46h and impede air flow and associated heat transfer by convection. Insert 56 could have a grid-like cross-sectional shape like insert 54 or any other cross-sectional shape that can be accommodated within the hollow 46h. It should be appreciated that the inserts 54, 56 are pre-formed before insertion into the respective hollow 32h, 46h, rather than injected into a hollow and expanded via self expansion, as occurs in the case of expanding foams. While the inserts may be formed from a material that is compressible, e.g., a foam material such as polyurethane, because the inserts 54, 56 are pre-formed, they can be handled as a stable part with stable, predefined dimensions, which are inserted into the structure, e.g., 32, having the hollow 32h that accommodates it. In case of a compressible insert 54, 56 that is compressed prior to insertion or forced into a hollow, e.g., 32h, the predefined expanded dimensions of the insert 54, 56 lead to a predictable expansion force and material density within the hollow in which it is placed. In comparison, a foamable polymer that is injected into a hollow as a liquid or gel has a rate of expansion which suggests the assembly of the hollow structure within a given time before the foam expands beyond the boundary of the hollow. Alternatively, use of an expanding foam to fill a hollow may involve an entry port into a pre-formed hollow, a fill strategy/injection tool, such as an injection nozzle which inserts into the cavity fully and then is gradually withdrawn as the foam is injected, the rates of withdrawal and injection being coordinated to insure even filling of the hollow, which, in the case of a window or door, could be a long, narrow cavity and require careful metering of the foam and movement of the nozzle to prevent gaps in filling, under-filling overfilling, bulging or stresses induced in the hollow structure. Moreover, drainage and airflows are prevented in a hollow filled by a foam expanded in place, such that accumulated water may become a source of mold.

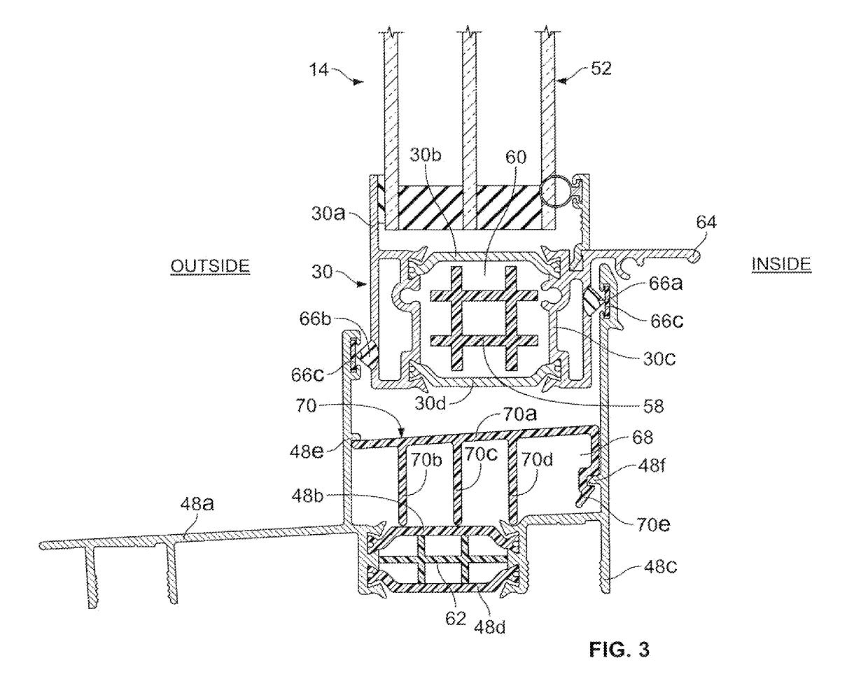

FIG. 3 shows the reception of lower sash 14 within the sill 48. As with the head rail 32, the sill rail 30 may be made from sub-elements 30a-30d. Subsections 30a and 30c may be formed of metal, e.g., aluminum and subsections 30b and 30d may be formed of a polymer and function as thermal breaks. Alternatively, all subsections 30a-30d may be made from aluminum or plastic. An insert 58 may perform thermal stabilization and/or air movement disruption functions. As with insert 54, the insert 58 may have a grid-like cross-section. The sill 48 has subsections 48a-48d, with subsections 48a and 48c optionally formed of metal and 48b and 48d optionally being thermal breaks. An insert 62 may be utilized for thermal stabilization and disrupting air movement, as in the case of the inserts 54, 56 and 58 described above. The lower sash 14 has a handle 64, which may function as a finger grip by which the sash 14 is raised and lowered and which aids in aligning seals 66a, 66b on the sash 14 with their complement 66c, 66d on the sill 48, when in the closed position. When in the closed position, a hollow 68 is defined between the sash 14 and the sill 48. An insert 70 having a bridging web 70a and extensions 70b-70e is placed into the hollow 68 to disrupt air movement in the hollow 68 to reduce heat transfer by convection. The extensions 70b-70e optionally perform two functions, viz., to mechanically support the insert 70 relative the sill 48 and to subdivide the hollow 68 into a plurality of smaller subareas. As before, the insert 70 may be made from a material having less heat conduction than the material from which the frame 16 or sashes 12, 14 are made. For example, if the frame 16 and/or sashes 12, 14 are made from an aluminum alloy, then the insert 70 may be made from plastic/polymer, such as PVC. The subdivision of the hollow 68 by the web 70a and extensions 70b-70e interrupts the movement of air supporting convection and places multiple heat barriers in the direction of heat transfer (between the outside and the inside). The sill 70 may have ledges 48e, 48f that interact with the insert 70 to retain it in position in the sill 48.

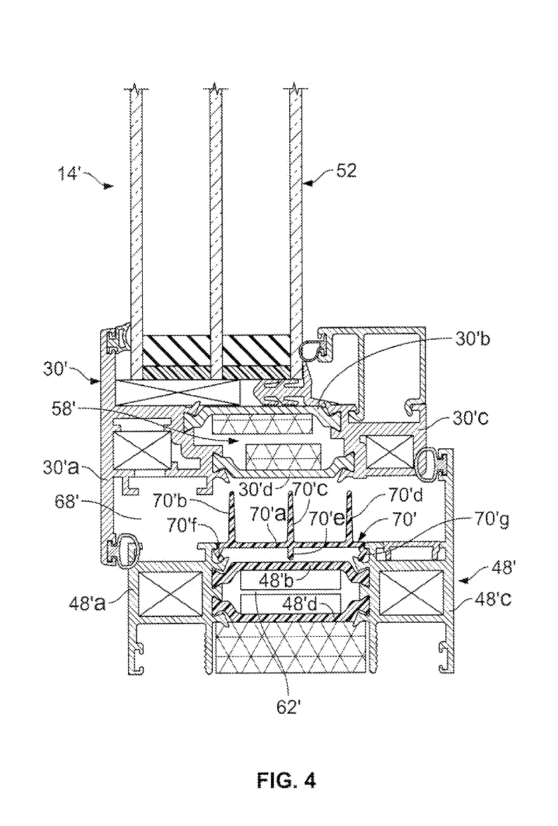

FIG. 4 shows a sill 48′ interacting with a sash 14′ of a casement/projected window 10′ (The same as window 10 of FIG. 1, but using hinge pivots 26, 28 rather than tracks 18, 20 for opening and closing.) The sill rail 30′ has subsections 30′a-30′d and may utilize an insert 58′ with features described above relative to insert 58 in FIG. 3. The sill 48′ may also have subsections 48′a-48′d and an insert 62′ like insert 62 of FIG. 3. An insert 70′ is retained between subsections 48′a and 48′c and has a plurality of upstanding extensions 70′b-70′d extending from web 70′a that project up into the hollow 68′ to divide the hollow 68′ into subareas, thereby disrupting air flows that support convective heat transfer through the hollow 68′. A downward extension 70′e divides the hollow 68′ into sub-areas and also may provide a mechanical support function. Extensions 70′f and 70′g mechanically clip the insert 70′ to the sill 48′. The dimensions of the insert 70′ may be modified, e.g., to extend up to the rail 30′ when the sash 14′ is in the closed position. The material chosen for forming the insert 70′ may be a rigid plastic/polymer such as PVC. Alternatively a flexible material may be employed, such as low durometer PVC. In one embodiment the insert 70′ is a composite of hard and soft materials, e.g., the web 70′a may be made from hard high durometer PVC and the extensions 70′b-70′d may be formed from soft, low-durometer PVC to allow deformation, e.g., to allow the rail 30′ to slide over the extensions, partially deforming them until it comes to a closed position where the extensions continue to maintain contact with the rail 30′.

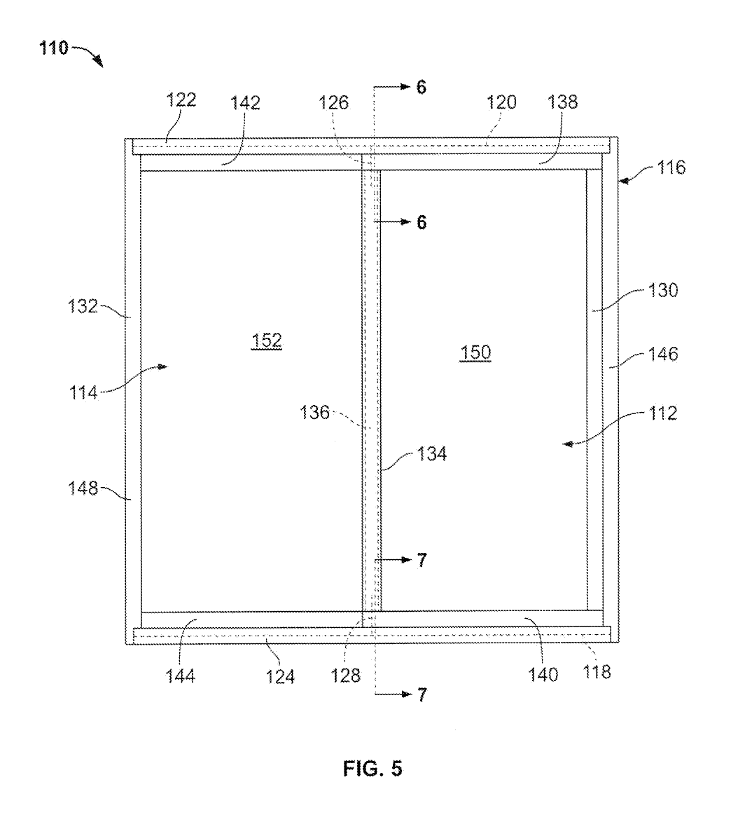

FIG. 5 shows a sliding window/door assembly 110 having a right panel 112 and a left panel 114 captured within a frame 116. In the case of a sliding door, typically at least one of the panels 112, 114 slides within opposing tracks 118, 120 (shown diagrammatically in dotted lines) in the head 122 and the sill 124 to allow opening/closing the door assembly 110. With hinged doors, hinges/pivots 126, 128 (diagrammatically shown in dotted lines) allow one or both panels 112, 114 to open in or out relative to the frame 116, with each opening panel 112 and/or 114 having a pair of hinges/pivots like 126, 128. The panels 112, 114 feature vertically oriented stiles 130, 132 and horizontally oriented rails 138, 140, 142, 144. The center check/meeting stile 134 of the right panel 112 coincides with the check/meeting stile 136 (dotted lines) of the left panel 114. The right and left sides of the frame 116 are the jambs 146, 148. The glazing 150, 152, e.g., made from glass or plastic, is held within the panels 112, 114.

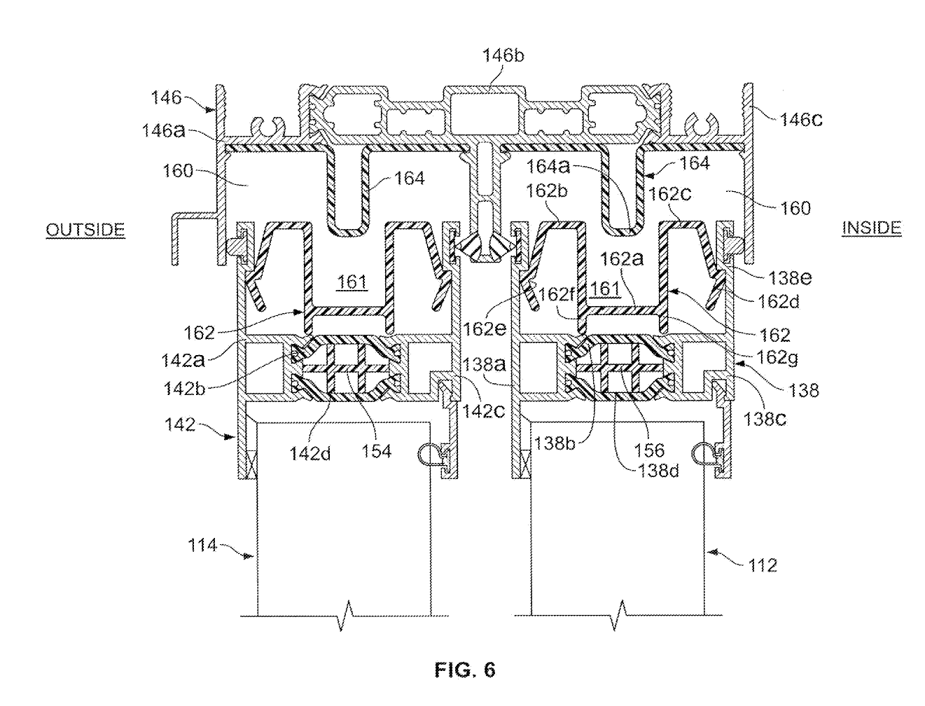

FIG. 6 shows that the rails 138, 142 may be formed from a plurality of sub-parts 138a-138d, and 142a-142d, respectively, e.g., in the form of extrusions, which are assembled together and which may include thermal breaks. For example 138b, 138d and 142b, 142d, may be made from a material, such as a polymer, with a conductivity that is less than that of the other subsections, 138a, 142a, etc., which may be made from a metal, such as, an aluminum alloy. The rails 138, 142 may be stabilized and/or have a reduced heat transfer due to inserts 154, 156, which may be made as described above in reference to the inserts 54, 56. The head 146 of the frame 116 may be a composite of a plurality of sub-sections 146a-146c, with 146b potentially being made of a material with lower conductivity to function as a thermal break. Hollows 160 between the rails 138, 142 and the head 146 of the frame 116, allow the panels 112, 114 to be lifted up into the head 146 for placement on the track 118 in the sill 124 and then lowered to rest on rollers (described below), while still being retained in the track 120 (See FIG. 5). Hollows 160 in the head 146 communicate with hollows 161 of the rails 138, 142. The hollows 160, 161 are subdivided into a plurality of smaller areas by inserts 162 and 164, which have complementary shapes. More specifically, inserts 162 have a U-shaped trough 162a disposed between two reversely bent arms 162b, 162c with ledges 162d, 162e that engage corresponding edges, e.g., 138e, 138f on the subparts 138c and 138a, respectively. Extensions 162f, 162g act as counteracting standoffs. Inserts 164 feature a U-shaped portion 164a depending from a web 164b. The U-shaped portion 164a extends slightly into the U-shaped trough 162b forcing any air traversing the hollows 160, 161 to follow a tortured, constricted path, thus reducing the movement of air and heat transfer due to convection. The complementary shapes of the U-shaped portions 164a and the troughs 162b permit the panels 112, 114 to be lifted relative to the head 146, allowing the panels 112, 114 to be installed into the frame 116. As can be appreciated from FIG. 6, panels 112 and 114 have similar features and relate to head 146 in a similar way. As an alternative embodiment, only one of the panels 112, 114 may be moveable, the other of which is stationary, such that the non-moving panel, e.g., 112 or 114, may utilize insulation and heat transfer suppression structures suitable for a stationary panel.

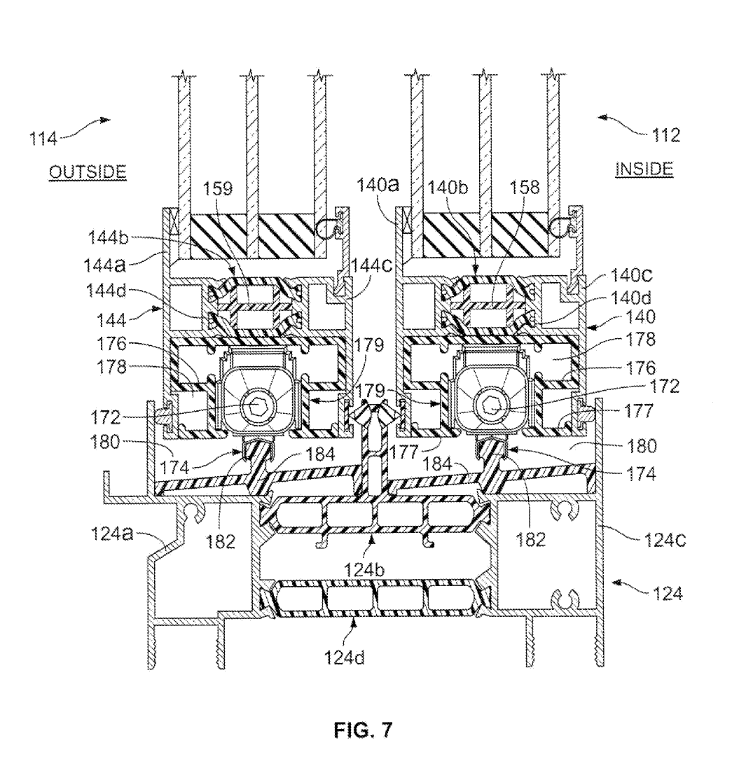

FIG. 7 shows the reception of rails 140, 144 within the sill 124. As with the head rails 138, 142, the sill rails 140, 144 may be made from sub-elements 140a-140d and 144a-144d, respectively, and may utilize inserts 158, 159 for thermal stabilization and/or to impede air movement. Subsections 140b, 140d and 144b, 144d may be formed of a polymer and function as thermal breaks. Like insert 54, the inserts 158 and 159 may have a grid-like cross-section or utilize secondary inserts like 58a, 58b, as described above. Each of the rails 140, 144 house roller assemblies 172 that permit the panels 112, 114 to be moveably supported on tracks 174 that are disposed in the sill 124. Inserts 176 are retained in each of the rails 140, 144 to decrease air movement and heat transfer through hollows 178 (of the rails 140, 144) and 180 of the sill 124. The inserts 176 have a hollow “T” cross-sectional shape extending up from webs 177. The webs 177 may segregate the hollow 178 from hollow 180 in the sill 124. The roller assemblies 172 are accommodated between the webs 177 within the upright shaft 179 of the inserts 176 and are optionally mechanically supported by the inserts 176.

The sill 124 has subsections 124a-124d, some of which, e.g., 124b and 124d may be made of a material with a lower heat conductivity than that of other subsections, e.g., 124a, 124e to functional as thermal breaks. The tracks 174 may also be made at least partially from a material exhibiting low heat conductivity, e.g., a rigid polymer and have an upstanding portion 182 that interacts with the roller assemblies 172 and a web portion 184. Since the web portions 184 subdivide hollows 180, they can diminish heat transfer attributable to convection through the hollows 180.

It will be understood that the embodiments described herein are merely exemplary and that a person skilled in the art may make many variations and modifications without departing from the spirit and scope of the claimed subject matter. For example, while the present disclosure refers to inserts for the structural members of moveable windows and doors, the teachings of the present disclosure could be applied to other structures employed in establishing and maintaining a building envelope, such as skylights and fixed window systems. In addition, the teachings of the present disclosure could also be applied to any hollow structural members, such as columns or beams in a building to achieve a reduction of heat transfer through those structures. While most hollow structural members commonly encountered are at least partially filled with air, the present disclosure is also applicable to hollow members containing other substances supporting convection, such as inert gases, like Nitrogen or Argon, or liquids, such as water. The insert may be dimensioned to be retrofitted to be accommodated within the hollow of an existing structural member design. All such variations and modifications are intended to be included within the scope of the appended claims.

We claim:

1. A device for members made from a first material having a first thermal conductivity and having a hollow supporting heat transfer by convection, comprising:
an insert having stable free-standing dimensions rendering the insert capable of insertion into the hollow and extending at least partially across the hollow when inserted therein, the insert capable of reducing the Nusselt number of the member when inserted into the hollow relative to the Nusselt number of the member without the insert present in the hollow.

2. The device of claim 1, wherein the insert is made from a second material with a second thermal conductivity and has a cross-sectional shape which at least partially subdivides the hollow into a plurality of sub-areas.

3. The device of claim 1, wherein the insert has a cross-sectional shape with a wall having a first orientation and a second wall having an orientation disposed at an angle relative to the first wall.

4. The device of claim 3, wherein the first wall is disposed perpendicular to the second wall.

5. The device of claim 1, wherein the insert has a cross-sectional shape with a plurality of walls defining a grid.

6. The device of claim 1, wherein the member receiving the insert is a member of a door.

7. The device of claim 1, wherein the member receiving the insert is a member of a window.

8. The device of claim 7, wherein the member is at least one of a rail, stile, head and sill of the window.

9. The device of claim 6, wherein the member is at least one of a rail, stile, head and sill of the door.

10. The device of claim 1, wherein the member is made at least partially of metal and the hollow has air therein.

11. The device of claim 10, wherein the metal is an aluminum alloy and the insert is formed from a plastic.

12. The device of claim 11, wherein the plastic is at least one of PVC and polyurethane.

13. The device of claim 1, wherein the member has a closed cross-sectional shape.

14. The device of claim 1, wherein the member has an open cross-sectional shape, the hollow communicating with a space exterior to the member.

15. The device of claim 14, wherein the cross-sectional shape is C-shaped.

16. The device of claim 15, wherein the insert has a first wall extending at least partially across the opening in the C-shape.

17. The device of claim 16, wherein the insert further includes a wall extending at an angle from the first wall.

18. The device of claim 17, wherein the first wall engages the member at either end to retain the insert in association with the member.

19. The device of claim 18, wherein the second wall engages another portion of the member to support the insert in the member.

20. The device of claim 18, wherein the second wall extends distally to the member.

21. The device of claim 20, wherein the insert is disposed in a sill and the second wall is flexible.

22. A sliding access device, comprising:
a frame with a head having a first open hollow;
a panel capable of sliding relative to the frame and having a head with a second open hollow, the first open hollow and the second open hollow facing each other;
a first insert capable of being received in the frame bridging the first open hollow;
a second insert capable of being received in the panel bridging the second open hollow.

23. The device of claim 22, wherein the first insert has a cross-sectional shape with a U shape, and the second insert has a cross-sectional shape with a U shape, the U shape of the first insert and the U shape of the second insert cooperatively mating, such that the panel can be lifted into the frame and the cooperation of the first insert and the second insert is capable of reducing the heat transfer through the conjoined first and second hollows when the panel is installed in the frame.

24. The device of claim 23, wherein the frame and panel are made of a first material with a given thermal conductivity and the first and second inserts are formed of a second material having a lesser thermal conductivity.

25. A sliding access device, comprising:
a frame with a sill;
a track disposed within the sill;
a panel with a hollow disposed along a bottom portion of the panel;
a roller assembly disposed in the hollow for supporting the panel slidably within the frame, the roller assembly engaging and rolling on the track;
an insert, received within the hollow, the insert having an adjacent wall that extends adjacent to the bottom portion defining the hollow along at least a portion thereof, a proximate wall positioned proximate to the roller assembly and a bridging wall extending between the adjacent wall and the proximate wall, the insert decreasing the Nusselt number of the sliding access device relative to the Nusselt number of the sliding access device without the insert.
